(19) United States
(12) Patent Application Publication
(10) Pub. No.: US 2022/0405667 A1
(43) Pub. Date: Dec. 22, 2022

(54) Automated In-Store Execution Issue Resolution System

(71) Applicant: Frito-Lay North America, Inc., Plano, TX (US)

(72) Inventors: Brian Corbett Kampe, Frisco, TX (US); John Stanley Phillips, Frisco, TX (US); Kimberly Diane Schimick, Garden Ridge, TX (US); Vergil Lavell Simpson, Frisco, TX (US); Andrew Troy Smith, Plano, TX (US)

(21) Appl. No.: 17/351,678

(22) Filed: Jun. 18, 2021

(51) Int. Cl. G06Q 10/06; G06Q 30/02; G06Q 10/08; F24F 11/63

(52) U.S. Cl. CPC G06Q 10/06315; G06Q 30/0201; G06Q 10/087; F24F 11/63; G06Q 10/20

(57) ABSTRACT

An in-store execution issue resolution system includes a processor communicatively coupled to a plurality of data sources, the data sources configured to provide data indicative of inventory and sales. The processor configured to, in response to data from at least one of the data sources indicating that one or more predefined conditions has been met, generate an alert requesting user input, in response to failing to receive user input within a predefined period, initiate at least one action to resolve the alert, and following the initiating of the at least one action, one of deactivate the alert, in response to detecting that initiating the at least one action caused the one or more conditions to clear, and maintain the alert in response to detecting that initiating the at least one action failed to cause the one or more conditions to clear.

### TECHNICAL FIELD

The present disclosure generally relates to an in-store rep retail alerting platform to identify execution opportunities involving planogram compliance, out-of-stocks, inventory issues, display execution, and various other in-store conditions.

### BACKGROUND

A need to promptly and efficiently resolve in-store execution issues in a retail setting cannot be overemphasized. Retailers and manufacturers of all sizes and levels of sophistication struggle to ensure that goods are directed to locations where they are most needed to avoid missed sales and customer dissatisfaction. Moreover, the nature of conducting business in fast-paced economies around the globe is such that lingering or recurring execution issues are not only frustrating, but are, indeed, unacceptable and likely to have immediate ramifications to business reputation and competitive standing.

### SUMMARY

A system of the present disclosure provides a comprehensive framework for identifying and resolving execution issues quickly and efficiently. Integrating a vast variety of tools and sources of information relied on by the principal stakeholders to resolve various execution concerns, the disclosed system delivers a resolution strategy that is both all-encompassing and readily adaptable to changing circumstances. Among other advantages, the system readily accounts for a human factor that plays an outsize role in shortcomings of the traditional execution issue resolution schemes.

At the outset, a system of the present disclosure synthesizes information from a large collection of data sources, be they sources relied on by manufacturers, suppliers, distributors, retailers, or logistics and field issue resolution personnel. The data may pertain, directly or indirectly, to inventory and sales, such as, but not limited to, production plans, delivery and fulfillment schedules, detailed historical and real-time sales and inventory data, forecasts, planograms, and product price lists. The system may analyze incoming information to discern a potential inventory shortfall or aging inventory, identify a diagnostic issue with a smart field refrigeration device, or detect another one of a myriad of exception circumstances that occur in the normal course of business.

Upon identifying a given issue, the system of the present disclosure generates one or more applicable alerts. Alerts may be ranked by priority, severity, and urgency and may be set when one or more conditions within one or more criteria (e.g., sets of conditions) have been met. Criteria and conditions for setting the alerts may vary geographically and/or temporally and may evolve over time with application of machine learning training datasets and other automated and manual tools.

As an end-to-end comprehensive issue resolution tool, the system of the present disclosure requests user input at one or more stages of alert identification, diagnosis, resolution, and confirmation process. Further; upon failing to receive the requested user input within a predefined period, the system can automatically initiate at least one action to resolve an alert. Some examples include the system automatically adding an item missing from the inventory to an upcoming order delivery, orders a set of replacement hardware parts to be delivered to a location ahead of an in-person technician visit, generates a recommendation for a sales or re-distribution opportunity, such as when an item missing from retail inventory is not available at a nearby distribution center or manufacturing plant, and so on.

Still further, in contrast to traditional execution management models, the system of the present disclosure requires a resolution action by ensuring that at least one condition for addressing the alert has been cleared before deactivating the alert. This closed-loop approach ensures that in-store execution issues are tracked until fully resolved and that lessons gained through the processes of identifying and resolving any deficiencies may be fully applied going forward.

### BRIEF DESCRIPTION OF THE DRAWINGS

The detailed description particularly refers to the following figures, in which:

FIG. 1 is a block diagram illustrating an exemplary implementation of an automated execution issue resolution system;

FIG. 2 is a block diagram illustrating another exemplary implementation of the automated execution issue resolution system;

FIG. 3 is a block diagram illustrating an exemplary implementation of an alert generation engine of the automated execution issue resolution system;

FIGS. 4 and 5 are block diagrams illustrating exemplary implementations of an analytic device and an environment generated by the analytic device of the present disclosure;

FIGS. 6 and 7 are block diagrams illustrating exemplary implementations of the field device and an environment generated by the field device of the present disclosure;

FIG. 8 is a block diagram illustrating an exemplary implementation of identifying whether one or more conditions for setting an alert have been met;

FIG. 9A is a block diagram illustrating exemplary interface layout for selecting one or more geographic locations for in-store execution issue resolution;

FIG. 9B is a block diagram illustrating exemplary interface layout for selecting one or more in-store execution issues for in-store execution issue resolution;

FIG. 9C is a block diagram illustrating exemplary interface layout for displaying stores with open in-store execution issues;

FIG. 9D is a block diagram illustrating exemplary interface layout of a detailed view of one or more in-store execution issues for in-store execution issue resolution;

FIG. 9E is a block diagram illustrating exemplary interface layout for providing status for one or more in-store execution issues for in-store execution issue resolution;

FIG. 9F is a block diagram illustrating exemplary interface layout for providing action for one or more in-store execution issues for in-store execution issue resolution; and

FIG. 10 is a block diagram illustrating an exemplary process flow for automating execution issue resolution.

### DETAILED DESCRIPTION

Sending field personnel to various store locations, whether or not a specific action to resolve an in-store execution issue is necessary, is inconvenient and expensive to both retailers and manufacturers. On the other hand, timelines continue to shrink in which a manufacturer is reasonably expected to identify and satisfy customer demand, address logistics and field personnel disruptions, or diagnose field equipment malfunction and affect applicable repairs. Traditional in-store execution issue tracking, such as, but not limited to, inventory management and field issue resolution schemes, embody collections of highly incongruent and complex legacy systems amounting to obstacles that often disrupt or, worse, cause a complete breakdown of issue resolution processes.

By way of an example, frontline personnel may rely on a very simple handheld device, such as a smart phone or another mobile device, to track down an item or location associated with a given inventory alert, confirm or deny that the alert was set correctly, and indicate what action if any was taken to resolve the alert. Functionality to support various stages of execution issue resolution may be distributed among different user applications, such that a frontline worker may be alerted to an inventory issue, or another in-store execution issue, using one user application, but may have to use another user application to get further details about the received alert, use still another user application to submit input indicating how the alert is to be or was resolved, and use yet another user application to take the specific action necessary to resolve the execution issue, such as, but not limited to, place an order for a product.

Each of the numerous user applications used to identify an in-store execution issue, generate a corresponding alert, and track alert resolution may have been developed on different platforms and written using different programming languages, and so may feature very different navigation layouts from one another, with some layouts being cumbersome or complex and with others confusing. In such an environment of highly disparate sources of information duplication and inconsistencies may increase the time the frontline workers need to resolve in-store execution issue resulting in customer dissatisfaction and missed sales.

A fully automated in-store execution issue resolution system of the present disclosure provides a comprehensive, end-to-end framework that collects and harmonizes vast data resources to anticipate and pinpoint a problem, involve principal stakeholders or automatically take specific actions to affect a quick and efficient resolution, and clear an issue alert strictly upon confirming that the field issue, such as, inventory shortfall, has been fully resolved.

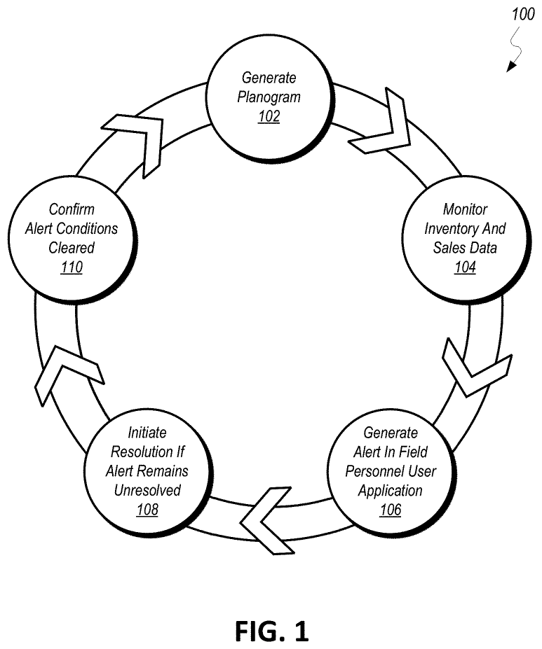

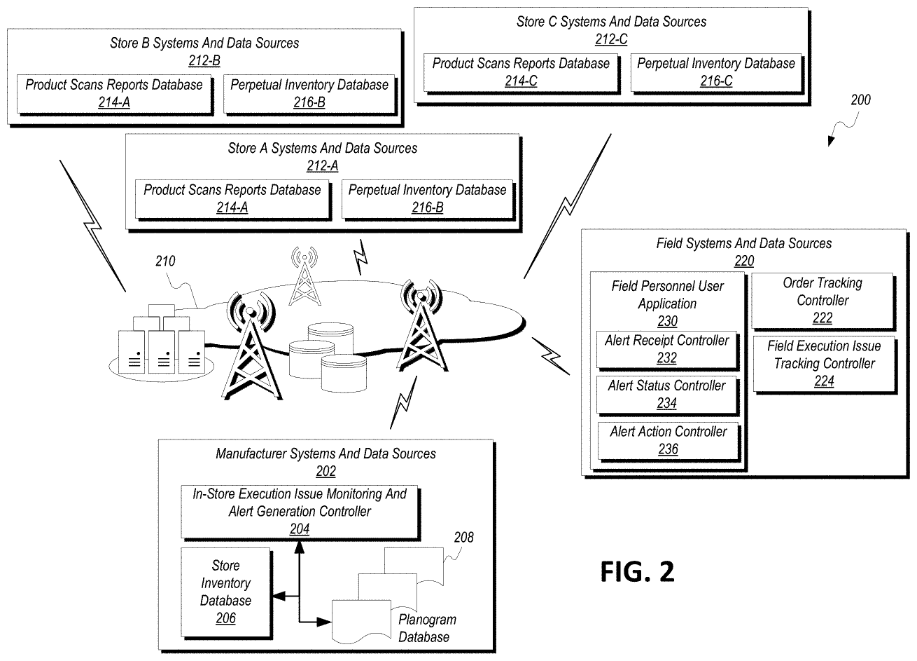

FIG. 1 illustrates an exemplary automated in-store execution issue resolution system 100 of the present disclosure. As described in reference to at least FIGS. 2-8, the automated in-store execution issue resolution system 100 may comprise a plurality of rule-based engines configured to continuously monitor inventory and sales data, generate alerts when certain conditions with respect to inventory and sale data have been met, initiate automatic resolution of the alert if the alert is not resolved by the field personnel within a predefined period, and confirm that the alert conditions have been cleared following application of the resolution actions. In other words, the automated in-store execution issue resolution system 100 establishes a comprehensive set of tasks and procedures applicable to resolve a variety of in-store execution issues.

Among advantages of the automated in-store execution issue resolution system 100 is adapting a universal approach to identify different types of issues, generate one or more alerts applicable to each issue type, automatically initiate one or more resolution actions if the alert is not resolved within a predefined period, and confirm that conditions for setting the alert have been resolved prior to clearing the alert. Still further, the automated in-store execution issue resolution system 100 is configured to adapt an intuitive and simplified user interface layout, such that essentially the same basic interface layout is presented to the field personnel across different types of inventory and sales issues.

In one example, the automated in-store execution issue resolution system 100 is configured to, e.g., at phase 104, access stored sales and inventory data for one or more predefined geographic regions, one or more retail stores within a given geographic region, or one or more retail store locations of a given retailer. The automated in-store execution issue resolution system 100 may be configured to convert, translate, or otherwise manipulate sales and inventory data to interpret the information. At least one rule-based engine of the automated in-store execution issue resolution system 100 is configured to access graphic data representative of a planogram of one retail store or several retail stores.

In one example, the automated in-store execution issue resolution system 100 is configured to, e.g., at phase 106, generate an alert based on the monitored inventory and sales data. In one example, the automated in-store execution issue resolution system 100 is configured to generate an alert in response to one or more values of the inventory and sales data being greater than or less than a predefined threshold. For planogram (POG) voids, the automated in-store execution issue resolution system 100 accesses daily scan data from a demand signal repository to identify items that are on the plan-o-gram, but are not selling at least one unit within a pre-defined timeframe (e.g., 7, 14, 21 or 28 days). As just one example, the system 100 generates POG void alerts for products that both have not had scan sales within a predefined period (e.g., 4 days, 10 days, 14 days, and so on) and have on-hand inventory over a predefined number of days (e.g., 3 days, 7 days, 8 days, and so on). The automated in-store execution issue resolution system 100 may apply different time periods with different product types, different retailers, and/or different geographic regions, prior to setting the alert. In some instances, the automated in-store execution issue resolution system 100 may set field personnel alerts for a given product based on a velocity with which that product is typically sold.

In still another example, prior to setting the alert, the automated in-store execution issue resolution system 100 evaluates whether the alert is serviceable by the frontline personnel, such as by evaluating on-hand inventory at a geographically proximate distribution centers and/or plant locations. The automated in-store execution issue resolution system 100 may determine that the alert is unserviceable and may suppress the alert, in response to, for example, but not limited to, determining that a product that is the subject of the alert is not carried in a distribution center and/or plant location that services the route. The automated in-store execution issue resolution system 100 may pass the unserviceable alerts to a dashboard so issues can be identified by product supply and corrected.

The automated in-store execution issue resolution system 100 supports several other rules-based alert types. For inventory alerts, retailer inventory data is accessed from the demand signal repository to create exception alerts when inventory levels fall below predefined targets. For example, alerts can be configured for low on-hand inventory (not enough), or for excess on-hand inventory (too much). Prompts and responses to alerts are specific to the alert type and the action that would be required to remediate.

The automated in-store execution issue resolution system 100 uses rule sets and data sets, each set having predefined prompts and responses, to identify and manage alerts for one or more of promotional execution, cooler in-stock alerts, and cooler health and maintenance alerts. Additional alert types include phantom inventory alerts, distribution voids alerts, customer service alerts, display placement alerts, and Bluetooth beacon data generated alerts, retailer-generated alerts, such as alerts related to specific initiatives (e.g., in-stock and online grocery fill rate, on-shelf customer availability, and out-of-stock alerts), increase sales potential and so on. The system of the present disclosure uses enterprise software dashboard to create a closed-loop process to manage modular (MOD) voids and/or POG voids.

The automated in-store execution issue resolution system 100 is configured to present alerts on the handheld device or smart phone of the in-store field agent who services the store. The automated in-store execution issue resolution system 100 presents alerts that are relevant to a given field worker based on a one-time user profile setup where information identifying the sales geography, route number and so on are selected from drop down menus. Following the initial setup, only the alerts that meet one or more criteria of the field worker profile are presented automatically going forward and are presented only to the specific field worker. The automated in-store execution issue resolution system 100 is configured to collect responses to the alerts that are then used to troubleshoot and create comprehensive dashboarding. The automated in-store execution issue resolution system 100 includes a standardized tile-based interface to consistently deliver retail execution alerts that enables rapid learning and adoption. The example automated in-store execution issue resolution system 100 includes a frontline personnel user application having a simplified user interface configured to receive input indicative of alert resolution from the frontline personnel.

The rule-based engine of the automated in-store execution issue resolution system 100 may be configured to execute cognitive services based on artificial intelligence and machine learning to search graphic data indicative of a retail planogram to identify an image of a product associated with a given in-store execution issue alert. The automated in-store execution issue resolution system 100 is configured to present the identified image of the product to a member of the field issue resolution team. Additionally or alternatively, the automated in-store execution issue resolution system 100 presents to the member of the field team an illustration indicating shelf placement of the product associated with the alert.

If alerts related to a given product ordering persist for a predefined timeframe, the automated in-store execution issue resolution system 100 is configured to, e.g., at phase 108, automatically add that given product to a next scheduled order, e.g., a push order. Alerts are filtered to report and action based on specific predefined criteria. Upon confirming that the item was previously successfully pushed or upon receiving field agent input indicating the alert has been resolved, the automated in-store execution issue resolution system 100 may clear the alert. Additionally, the automated in-store execution issue resolution system 100 may include a plurality of rule-sets specific to retailers, product types or channels. In an example, products needed to correct store and item planogram voids are accumulated in two data files, one file capturing bin route types and another file for distribution center-based routes. The automated in-store execution issue resolution system 100 may use the files to ensure that the products are delivered to the store during a next delivery trip along the route of the store.

The automated in-store execution issue resolution system 100 is configured to receive input from the field agent indicating a manual order placement as part of the alert resolution. If the alert response requires product ordering, the field agent can select a universal product code (UPC) barcode icon in the banner of the alert and display the UPC barcode for the product. The field agent may scan the UPC image with a handheld ordering device, thereby adding the product to a next order submitted to the distribution center or the manufacturing plant.

The automated in-store execution issue resolution system 100 reprocesses data daily. If the field representative responds to the alert, the automated in-store execution issue resolution system 100 will not send another alert for that item/store combination for a configurable number of days (e.g., 5 days). If no response is given by the field representative and the condition still exists, the automated in-store execution issue resolution system 100, e.g., at phase 110, continues to send the alerts until occurrence of one of: a sale of the item being detected, feedback or other input being received from the field representative, or the item having been added to an upcoming delivery order.

Referring now to FIG. 2, an example diagram 200 illustrates a plurality of components of the automated in-store execution issue resolution system 100. The components of the automated in-store execution issue resolution system 100 include a plurality of categories of systems and data sources, such as, but not limited to, one or more manufacturer systems and data sources 202, store systems and data sources 212a, 212b, 212c, and field systems and data sources 220.

The manufacturer systems and data sources 202 may include an in-store execution issue monitoring and alert generation controller 204, a store inventory database 206, and a planogram database 208. The store systems and data sources 212 of a plurality of stores may include a store product scan reports database 214 and a store perpetual inventory database 216. The field systems and data sources 220 may include a field order tracking controller 222, a field execution issue tracking controller 224, a field personnel user application 230 that, in turn, includes a field alert receipt controller 232, a field alert status controller, and a field alert action controller 236.

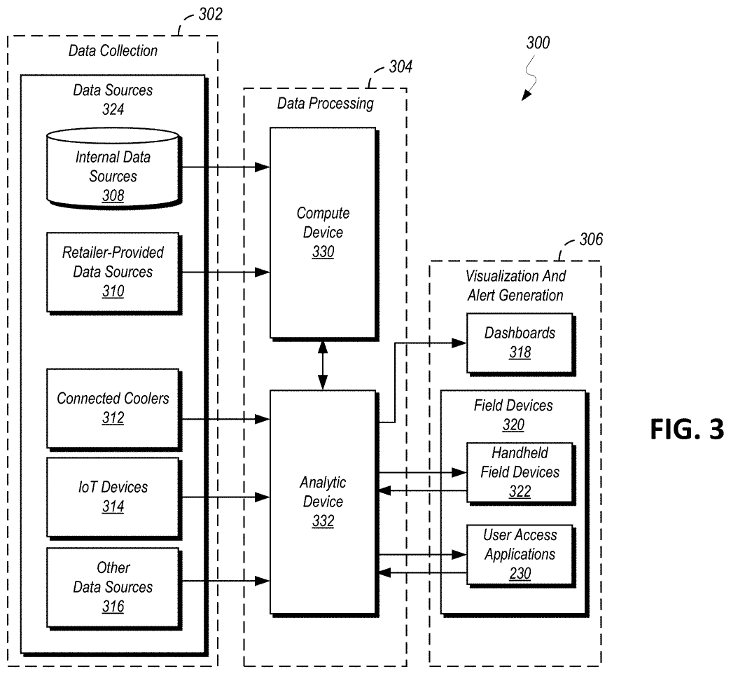

The manufacturer systems and data sources 202, the store systems and data sources 212a, 212b, 212c, and the field systems and data sources 220 may be communicatively coupled with one another via a network 210. The network 210 may be embodied as any type of network capable of communicatively connecting the manufacturer systems and data sources 202, the store systems and data sources 212a, 212b, 212c, and the field systems and data sources 220, such as a cloud network, an Ethernet-based network, etc. Accordingly, the network 210 may be established through a series of links, switches, interconnects, routers, and other network devices which are capable of connecting the manufacturer systems and data sources 202, the store systems and data sources 212a, 212b, 212c, and the field systems and data sources 220 of the network 210. As will be described in further detail below (see, e.g., FIG. 3), the manufacturer systems and data sources 202, the store systems and data sources 212a, 212b, 212c, and the field systems and data sources 220 form a comprehensive data processing, analysis, and exchange system.

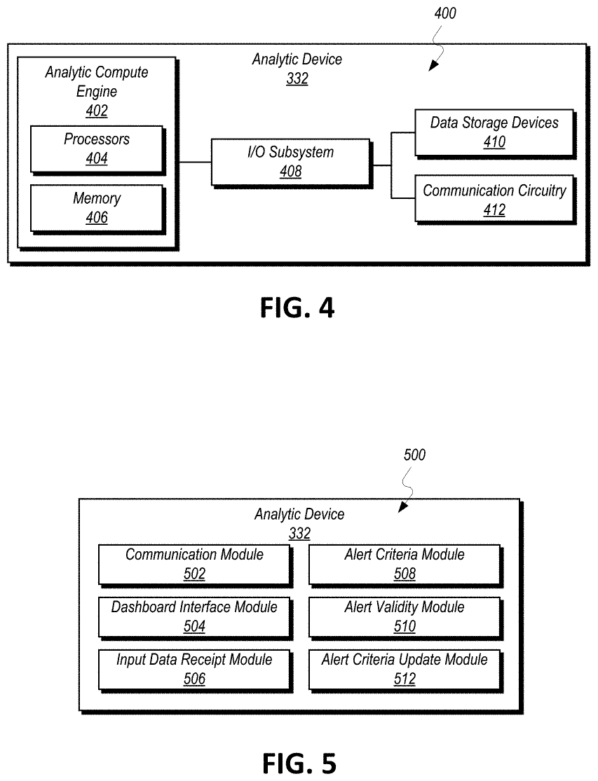

FIG. 3 illustrates an exemplary implementation 300 of the automated in-store execution issue resolution system 100. Data collection operations 302 include collecting data provided by data sources 324 (e.g., data sources associated with one or more of the manufacturer systems and data sources 202, the store systems and data sources 212, and the field systems and data sources 220). As described in reference to at least FIGS. 4-7, data from one or more data sources 324 is provided to compute device 330 and the analytic device 332 for further processing. Exemplary data sources 324 include internal data source(s) 308, retailer-provided data source(s) 310, connected cooler(s) 312, Internet of Things (loT) device(s) 314, and other data source(s) 316. It is contemplated that one or more data sources 324 provide data to the compute device 330 and/or to the analytic device 332 in real-time, e.g., near-simultaneous manner, or using time-delayed methodology, e.g., periodic or aperiodic manner, on at least one of a continuous and time-varying basis. Moreover, a given data source 324 may use one or a combination of aforementioned data transfer methodologies and cadences and may switch among the various methodologies and cadences in a course of operation. Additionally or alternatively, data source(s) 324 may provide demand-based information updates in response to a corresponding update request from at least one of the compute device 330 and the analytic device 332.

Internal data source(s) 308 comprise digital and non-digital data structures maintained by a manufacturer, producer, or distributor in a regular course of business. Internal data source(s) 308 include databases, spreadsheets, ledgers, receipts, invoices, and other documentation types indicating manufacturer production and/or movement of inventory, such as, orders, sales, shipments, deliveries, and returns. Retailer-provided data source(s) 310 comprise digital and non-digital types of records maintained by a retailer in a regular course of business. Retailer-provided data source(s) 310 include databases, spreadsheets, ledgers, receipts, invoices, and other documentation types indicating changes in inventory levels and movement of merchandise, such as, orders, sales, shipments, deliveries, and returns. While internal data source(s) 308 and retailer-provided data source(s) 310 are illustrated as separate data source(s) 106, an exemplary implementation of the system 100 may include incorporating the retailer-provided data source(s) 310 to be a part of internal data source(s) 308 and vice versa. Internal data source(s) 308 and retailer-provided data source(s) 310 serve as input data source(s) 324 to the compute device 330. In other exemplary implementations of the system 100, one or more of the internal data source(s) 308 and retailer-provided data source(s) 310 serve as a direct input to the analytic device 332.

Each of connected cooler(s) 312, loT device(s) 314, and other data source(s) 316 is communicatively coupled to the analytic device 332 and configured to provide data to the analytic device 332. Connected cooler(s) 312 may be embodied as any type of device or collection of devices capable of performing the various described functions. Connected cooler(s) 312 may comprise smart appliance(s), container(s), or compartment(s) including one or more sensors and compute devices configured to actively monitor, track, and report inventory levels to the analytic device 332. Such appliance(s), container(s), or compartment(s) may be known as “smart” because they include some amount of processing power. Connected cooler(s) 312 may comprise appliance(s) or container(s) housed and maintained within a manufacturer/producer facility, a retail/distribution facility, or a combination thereof.

loT device(s) 314 may be embodied as any type of device or collection of devices capable of performing various functions, including, but not limited to, automatic identification and data capture (AIDC) technology-based devices, such as radio frequency identification (RFID) tags, beacons, and smart barcodes. loT device(s) 314 may embody, or operate as a part of, a larger intelligent asset management system that includes transmitters, receivers, antennae, readers and scanners communicatively connected to one or more servers for processing, storing, and distributing data captured by the loT device(s) 314. Other data source(s) 316 may be embodied as any type of device, system, and data structure or collection of devices, systems, and data structures capable of performing functions, including, but not limited to, traceability, identification, positioning, security, monitoring, and tracking devices, systems, inventory control and feedback, and data structures.

As described in reference to FIGS. 4-7, data processing operations 304 may be performed by at least one of the compute device 330 and the analytic device 332. In example implementations of the system 100, the compute device 330 is communicatively coupled to the analytic device 332 and configured to transmit data to the analytic device 332 and to receive data from the analytic device 332.

Analytic device 332 is capable of generating output(s) to support data visualization and alert generation operations 306. Operations 306 may be performed by way of one or more software application-based dashboard(s) 318 monitored and operated by the manufacturer/producer, distributor, and other parties. Data visualization and alert generation operations 306 may be further performed by the field device(s) 320. Field device(s) 320 may be embodied by any device or collection of devices such as, but not limited to, handheld field device(s) 322 and user access application(s) 230 capable of performing the various described functions.

Handheld field device(s) 320 may be embodied as any device or collection of devices capable of performing various functions, such as, but not limited to, a computer, a smart phone, a tablet computer, a laptop computer, a notebook computer, a mobile computing device, a desktop computer, a work station, a cellular telephone, a handset, a messaging device, a vehicle telematics device, a network appliance, a web appliance, a distributed computing system, a multiprocessor system, a consumer electronic device, a digital television device, and/or any other computing device. Exemplary handheld field device(s) 320 include one or more audio and visual output devices, such as, but not limited to, speakers and displays, and one or more audio and visual input devices, such as, but not limited to, microphones and cameras. Example handheld device(s) 320 may receive user input using one or more user input interfaces, such as, but not limited to, touch screens, touch pads, digital and/or physical buttons, keys, and keyboards. Additionally or alternatively, handheld device(s) 320 may be configured to perform speech, face, and hand gesture recognition and/or receive user input by way of voice commands, stylus inputs, single- or multi-touch gestures, and touchless hand gestures.

User access application(s) 230 may be embodied as any computer program or collection of computer programs capable of performing various described functions. User access application(s) 230 includes interface accessible via one or more mobile or stationary user access systems, such as, but not limited to, a computer, a smart phone, a tablet computer, a laptop computer, a notebook computer, a mobile computing device, a desktop computer, a work station, a cellular telephone, a handset, a messaging device, a vehicle telematics device, a network appliance, a web appliance, a distributed computing system, a multiprocessor system, a consumer electronic device, a digital television device, and/or any other computing device.

FIG. 4 illustrates an exemplary implementation 400 of the analytic device 332. While the illustrated implementation 400 describes only the analytic device 332, in other examples, the compute device 330 may be embodied to include similar components configured to perform similar operations to those described, with respect to the analytic device 332. The analytic device 332 includes an analytic compute engine 402, an I/O subsystem 408, one or more data storage devices 410, and communication circuitry 412. It will be appreciated that the analytic device 332 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The analytic compute engine 402 may be embodied as any type of device or collection of devices capable of performing the described various compute functions. In some embodiments, the analytic compute engine 402 may be embodied as a single device, such as an integrated circuit, an embedded system, a field-programmable gate array (FPGA), a system-on-a-chip (SOC), an application-specific integrated circuit (ASIC), reconfigurable hardware or hardware circuitry, or other specialized hardware to facilitate performance of the functions described herein. In some embodiments, the analytic compute engine 402 may include, or may be embodied as, one or more processors 404 (i.e., one or more central processing units (CPUs)) and memory 406.

The processor(s) 404 may be embodied as any type of processor capable of performing the described functions. For example, the processor(s) 404 may be embodied as one or more single-core processors, one or more multi-core processors, a digital signal processor, a microcontroller, or other processor or processing/controlling circuit(s). In some embodiments, the processor(s) 404 may be embodied as, include, or otherwise be coupled to an FPGA, an ASIC, reconfigurable hardware or hardware circuitry, or other specialized hardware to facilitate performance of the described functions.

The memory 406 may be embodied as any type of volatile (e.g., dynamic random access memory (DRAM), etc.) or non-volatile memory or data storage capable of performing the described functions. It will be appreciated that the memory 406 may include main memory (i.e., a primary memory) and/or cache memory (i.e., memory that can be accessed more quickly than the main memory). Volatile memory may be a storage medium that requires power to maintain the state of data stored by the medium. Non-limiting examples of volatile memory may include various types of random access memory (RAM), such as DRAM or static random access memory (SRAM).

The analytic compute engine 402 is communicatively coupled to other components of the compute device 330 via the I/O subsystem 408, which may be embodied as circuitry and/or components to facilitate input/output operations with the processor 404, the memory 406, and other components of the compute device 330. For example, the I/O subsystem 408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 408 may form a portion of a system-on-a-chip (SoC) and be incorporated, along with the analytic compute engine 402 (e.g., the processor 404, the memory 406, etc.) and/or other components of the analytic device 332, on a single integrated circuit chip.

The one or more data storage devices 410 may be embodied as any type of storage device(s) configured for short-term or long-term storage of data, such as, for example, memory devices and circuits, memory cards, hard disk drives, solid-state drives, or other data storage devices. Each data storage device 410 may include a system partition that stores data and firmware code for the data storage device 410. Each data storage device 410 may also include an operating system partition that stores data files and executables for an operating system.

The communication circuitry 412 may be embodied as any communication circuit, device, or collection thereof, capable of enabling communications between the analytic device 332 and other computing devices, such as the compute device 330, the data sources 324, the field devices 320, etc., as well as any network communication enabling devices, such as a gateway, an access point, other network switches/routers, etc., to allow ingress/egress of network traffic. Accordingly, the communication circuitry 412 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

It should be appreciated that, in some embodiments, the communication circuitry 412 may include specialized circuitry, hardware, or combination thereof to perform pipeline logic (e.g., hardware algorithms) for performing the functions described herein, including processing network packets (e.g., parse received network packets, determine destination computing devices for each received network packets, forward the network packets to a particular buffer queue of a respective host buffer of the compute device 330, etc.), performing computational functions, etc.

In some embodiments, performance of one or more of the functions of the described communication circuitry 412 may be performed by specialized circuitry, hardware, or combination thereof of the communication circuitry 412, which may be embodied as a system-on-a-chip (SoC) or otherwise form a portion of a SoC of the compute device 330 (e.g., incorporated on a single integrated circuit chip along with a processor 404, the memory 406, and/or other components of the compute device 330). Alternatively, the specialized circuitry, hardware, or combination thereof may be embodied as one or more discrete processing units of the compute device 330, each of which may be capable of performing one or more of the described functions.

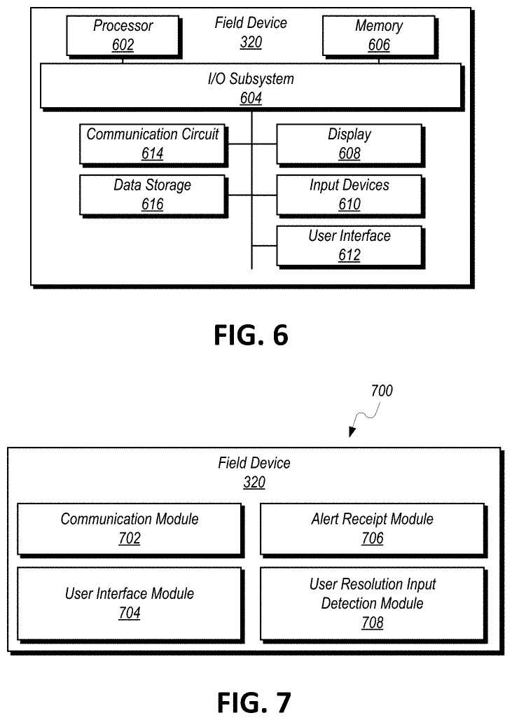

Referring now to FIG. 5, in use, the analytic device 332 establishes an environment 500. The illustrative environment 500 includes a communication module 502, a dashboard interface module 504, an input data receipt module 506, an alert criteria module 708, an alert validity module 510, and an alert criteria update module 512. Each of the modules and other components of the environment 500 may be embodied as firmware, software, hardware, or a combination thereof. For example the various modules, logic, and other components of the environment 500 may form a portion of, or otherwise be established by, the processor 404, the I/O subsystem 408, an SoC, or other hardware components of the analytic device 332. As such, in some embodiments, any one or more of the modules of the environment 500 may be embodied as a circuit or collection of electrical devices (e.g., a communication circuit, a user interface circuit, an input data receipt circuit, an alert criteria circuit, an alert validity circuit, an alert criteria update circuit, etc.).

The communication module 502 is configured to facilitate communications between the analytic device 332 and other devices of the system 100. For example, the communication module 502 may establish communication links, via the communication circuit 412, with one or more of the compute device 330, the data sources 324, and/or the field devices 320 to retrieve raw and processed inventory tracking data, generate inventory alerts, receive and analyze user input regarding an alert resolution, and clear or maintain the inventory alerts based on received user input and/or failure to receive user input within a predefined period.

The dashboard interface module 504 is configured to provide an interface to a user for interaction with the analytic device 332. For example, the dashboard interface module 504 may receive user input from the user interface of the dashboards 318.

The input data receipt module 506 is configured to receive, via the communication module 502, data from the data sources 324, such as, the internal data sources 308, the retailer provided data sources 310, the connected coolers 312, the loT device 314, and other data sources 316. As described in reference to FIG. 3, the analytic device 332 may receive input data either, directly, from the data sources 324 themselves (may be referred to as, “raw data”) and/or, indirectly, such as via the compute device 330 (may be referred to as, “processed data”).

The alert criteria module 508 is configured to analyze input data to determine whether criteria for issuing an alert for a certain retail or geographic location has been met. The alert criteria module 508 is communicatively coupled to the dashboard 318 and the field devices 320. Upon determining that one or more criteria for setting an alert has been met, the alert criteria module 508 causes the field device 320 to update information rendered on the display 608, as discussed in more detail below.

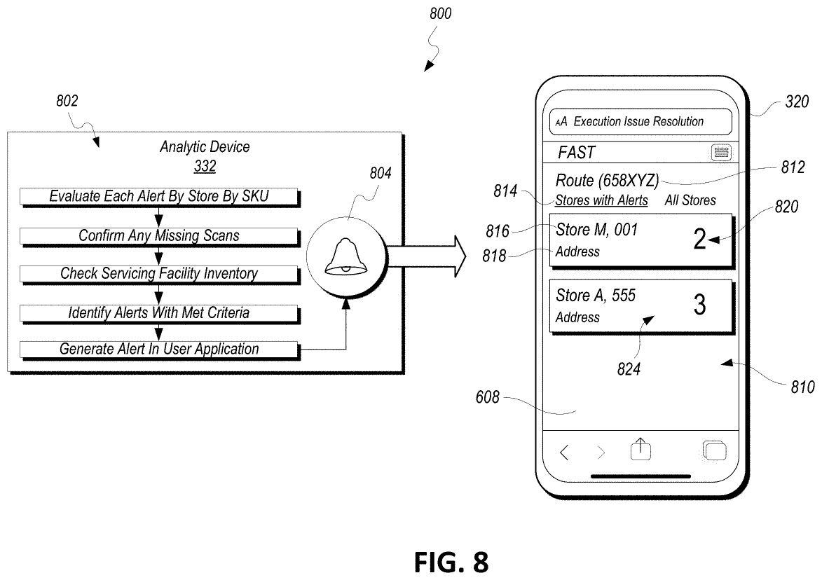

Referring now to FIG. 6, one of the plurality of the illustrative field devices 320 is shown and it includes a processor 602, an I/O subsystem 604, a memory 606, a display 608, input device(s) 610, a user interface 612, a communication circuit 614, and a data storage 616. Of course, in other embodiments, the field device 320 may include alternative or additional components, such as those commonly found in a server, router, switch, or other network device. Additionally, in some embodiments, one or more of the illustrative components may be incorporated in, or otherwise form a portion of, another component. For example, the memory 606, or portions thereof, may be incorporated in one or more processors 606.

The processor 602 may be embodied as any type of processor capable of performing the described functions. The processor 602 may be embodied as a single or multi-core processor(s), digital signal processor, microcontroller, or other processor or processing/controlling circuit. The memory 606 may be embodied as any type of volatile or non-volatile memory or data storage capable of performing the functions described herein. In operation, the memory 606 may store various data and software used during operation of the field device 320, such as operating systems, applications, programs, libraries, and drivers. The memory 606 is communicatively coupled to the processor 602 via the I/O subsystem 604, which may be embodied as circuitry and/or components to facilitate input/output operations with the processor 602, the memory 606, and other components of the field device 320. For example, the I/O subsystem 604 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 604 may form a portion of a system-on-a-chip (SoC) and be incorporated, along with the processors 602, the memory 606, and other components of the field device 320, on a single integrated circuit chip.

The display 608 may be embodied as any type of display capable of displaying digital information to a user such as a liquid crystal display (LCD), a light emitting diode (LED), a plasma display, a cathode ray tube (CRT), or other type of display device. As described below, the display 608 may be used to display a graphical user interface or other information to the user of the field device 320. Additionally, in some embodiments, the field device 320 may include a touch screen coupled to or incorporated in the display 608. The touch screen may be used to receive user tactile input.

The communication circuit 614 may be embodied as any communication circuit, device, or collection thereof, capable of enabling communications between the field device 320 and the analytic device 332 and/or the compute device 330 via the network 210. To do so, the communication circuit 614 may be configured to use any one or more communication technology and associated protocols (e.g., Ethernet, Bluetooth®, Wi-Fi®, WiMAX, etc.) to effect such communication.

The data storage 616 may be embodied as any type of device or devices configured for short-term or long-term storage of data such as, for example, memory devices and circuits, memory cards, hard disk drives, solid-state drives, or other data storage devices. The data storage 616 and/or the memory 606 may store various other data useful during the operation of the field device 320.

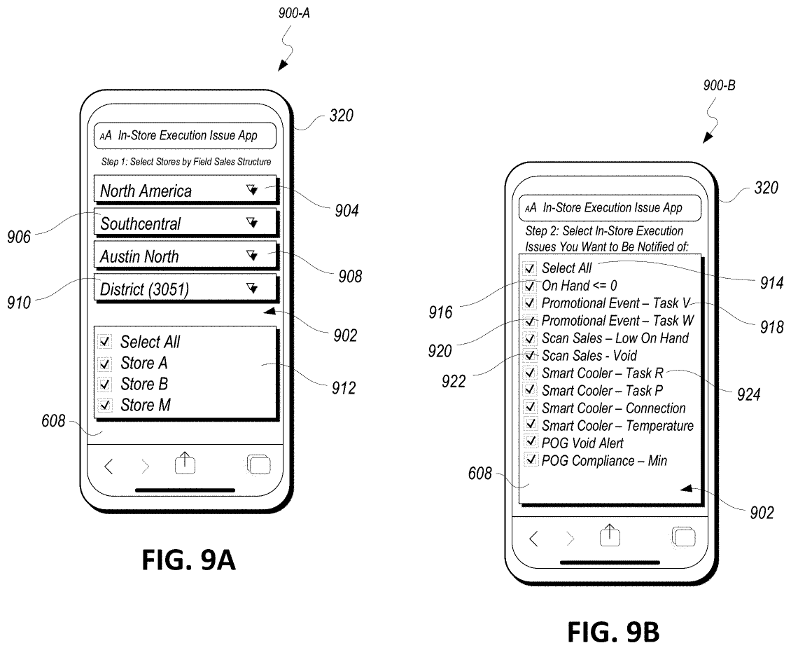

Referring now to FIG. 7, in use, the field device 320 establishes an environment 700. The illustrative environment 700 includes a communication module 702, a user interface module 704, an alert receipt module 706, and a user resolution input detection module 708. Each of the modules and other components of the environment 700 may be embodied as firmware, software, hardware, or a combination thereof. For example the various modules, logic, and other components of the environment 700 may form a portion of, or otherwise be established by, the processor 602, the I/O subsystem 604, an SoC, or other hardware components of the field device 320. As such, in some embodiments, any one or more of the modules of the environment 700 may be embodied as a circuit or collection of electrical devices (e.g., a communication circuit, a user interface circuit, an alert receipt circuit, a user resolution input detection circuit, etc.).

The communication module 702 is configured to facilitate communications between the field device 320 and other devices of the system 100. For example, the communication module 702 may establish communication links, via the communication circuit 614, with one or more of the analytic device 332 and/or the compute device 330 to retrieve inventory alerts or share received user resolution input regarding a previously generated inventory alert.

The user interface module 704 is configured to provide an interface to a user for interaction with the field device 320. For example, the user interface module 604 may receive user input from the user interface 612 and/or the touchscreen of the display 608. Additionally the user interface module 704 is configured to control or manage the input devices 610. For example, the user interface module 704 may receive or detect inventory item status via the input devices 610 as discussed in more detail below.

The alert receipt module 706 is configured to receive, via the communication module 702, data indicating that an alert at a certain retail location has been identified and that items may need restocking. The alert receipt module 706 is communicatively coupled to the user interface module 704. Upon receiving an alert from the analytic device 332, the alert receipt module 706 causes the user interface module 704 to update information rendered on the display 608 as discussed in more detail below.

The user resolution input detection module 708 is configured to detect that the user entered resolution input regarding a previously generated alert. A user resolution input may be entered using one or more of the user interface 612 and a touch screen connected to the display 608. In an illustrative embodiment, the user resolution input detection module 608 interprets data input received via the input device(s) 610 to detect resolution input from the user regarding a previously generated alert. The user resolution input detection module 708 transmits via the communication module 702 data indicating the received user resolution input regarding a previously generated alert to the analytic device 332.

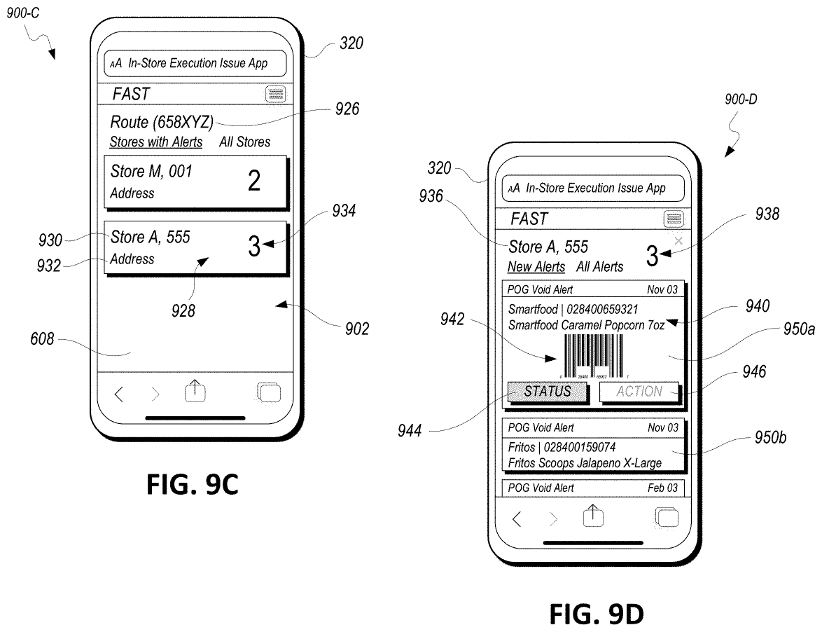

FIG. 8 illustrates exemplary implementation 800 for identifying whether one or more conditions 802 for setting an alert 804 have been met. FIG. 8 also illustrates an exemplary layout 810 of a user interface rendered on the display 608 of the field device 320. As discussed previously (see FIG. 6), the display 608 may be a touch screen and may be embodied as any type of touch screen capable of generating input data in response to being touched by the user of the field device 320. The display 608 may be embodied as, for example, a resistive touch screen, a capacitive touch screen, or a camera-based touch screen.

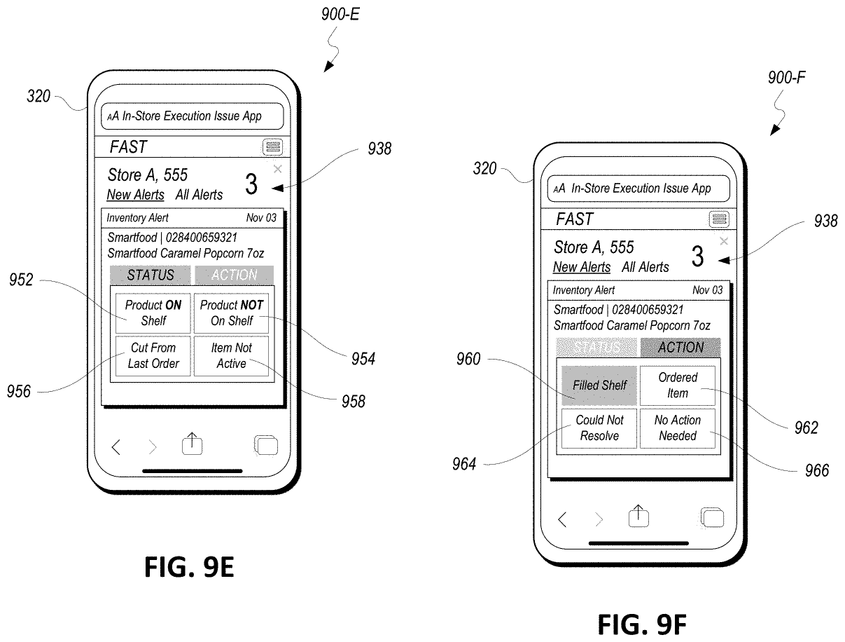

Upon activation, the application 230 automatically displays system alerts and status updates to the frontline agent via the user interface. As described in reference to FIGS. 9A-9F, the layout 810 of the user interface includes a designated route indication 812, a stores with alerts list 814, and alert indictors 824. Each alert indictor 824 identifies a retail store 816, an associated geographic location 818 of the retail store 816, and a number of active alerts 820. Of course, in other embodiments, layouts 810 of the field device 320 can include alternative or additional indicators, features, and controls frequently found in UI architecture design, such as checkboxes, radio buttons, dropdown lists, list boxes, buttons, toggles, text fields, date field, breadcrumb, slider, search field, pagination, slider, tags, icons, tooltips, icons, progress bar, notifications, message boxes, and modal windows. Each of the alert indicators 824 may comprise keys or buttons linked to more detailed views, as discussed in more detail below.

An input detection module of the field device 320 may provide an indication to a software application presently executing on the field device 320, such as via an application program interface (API). Accordingly, the software application may perform a desired task based on the indication.

FIGS. 9A-9F illustrate exemplary interfaces of one of the field device(s) 320 of the system 200. The field device(s) 320 illustrated in FIGS. 9A-9F may be the handheld field device(s) 320 communicatively connected with the analytic device 332 that performs data processing operations 304.

FIG. 9A illustrates an exemplary layout 900-A of a user interface 902 rendered on the display 608 of the field device 320. In particular, the layout 900-A comprises selection choices corresponding to one or more stores located within a predefined geographic area associated with the in-store execution issue alert. The layout 900-A may be presented in response to request to set up a new execution issue monitoring account, in response to a request to alter an existing execution issue monitoring account, or in response to a combination of these or other inputs or requests. In an example, the layout 900-A may be a step in a multi-step user profile setup.

In some instances, one or more selections by a user within the layout 900-A, such as one or more menu selections, one or more checked or unchecked boxes, and so on, may be associated with a username and/or a user identifier and stored in memory of the field device 320 for reference during subsequent access by the user. Of course, in other embodiments, the layout 900 may be navigated to by way of additional or alternative menu selections and/or invoked automatically in response to activation of the software application or when the field device 320 is detected to be in geographic proximity to the retail store where an execution issue alert has been identified.

Geographic selections 904, 906, 908, 910 are user-activated controls indicating different divisions or subdivisions of a geographic area associated with the in-store execution issue alert. In one example, one or more of the geographic selections 904, 906, 908, 910 represent progressively smaller geographic divisions of other geographic selections 904, 906, 908, 910. As another example, a first geographic selection 904 is indicative of a country or a continent, a second geographic selection 906 is indicative of a portion of the first geographic selection 904, such as a region within a country or on a continent, a third geographic selection 908 is indicative of a portion of the second geographic selection 906, such as a metro area within a region, and the fourth geographic selection 910 is indicative of a portion of the third geographic selection 908, such as a district of a metro area, and so on.

While the geographic selections 904, 906, 908, 910 are described, of course, different categories of divisions, subdivisions, or tiers, as well as, a different number of divisions, subdivisions, or tiers are also contemplated. The geographic selections 904, 906, 908, 910 may operate independently, such that a desired geographic region may be selected without regard as to an order or layout the geographic selections 904, 906, 908, 910. In other examples, a subsequent one of the geographic selections 902, 904, 906, 908 is populated in response to and based on a preceding one selected by the user, such that a menu of the second geographic selection 906 is populated in response to and based on a user selection having been made within a menu of the first geographic selection 904, and so on. A store listing 912 may be presented within a smallest selected geographic selection, e.g., the store listing 912 may list stores within the fourth geographic selection 910.

FIG. 9B illustrates an exemplary layout 900-B of a user interface 902 rendered on the display 608 of the field device 320. In particular, the layout 900-B comprises selection choices corresponding to one or more in-store execution issues for in-store execution issue resolution. The layout 900-B may include a predefined list of in-store execution issues such that one or more items of the issues list may be selected (a selection indicated by a checked box, a highlight of the text of the item), unselected, added to a separate sub-list of items that a user wishes to be notified of. Additionally or alternatively, the user may have an option to select from a list of one or more execution issues that the user wishes to exclude from their notifications. Likewise, the user may be able to select/deselect a “Select All” item 914 to select/deselect all items from the list of the execution issues.

As just some examples, the execution issues may include an on-hand quantity 916, a promotional event task V 918, a promotional event task W 920, a scan sales void 922, a smart cooler task R 924, and so on. Each of the execution issues 916, 918, 920, 922, 924 may include one or more associated conditions that need to occur prior to the alert being set. As with the layout 900-A, the layout 900-B may be presented in response to request to set up a new execution issue monitoring account, in response to a request to alter an existing execution issue monitoring account, or in response to a combination of these or other inputs or requests. Additionally or alternatively, the layout 900-B may be a step in a multi-step user profile setup.

FIG. 9C illustrates an exemplary layout 900-C of a user interface 902 rendered on the display 608 of the field device 320. In one example, the layout 900-C may be generated in response to and based on selections made in one or both of the layouts 900-A and 900-B. In particular, the layout 900-C comprises one or more stores with one or more open in-store execution issues. The layout 900-C includes a route indication 926 and alert indictors 928 associated with stores located along the route corresponding to the route indication 926. Each alert indictor 928 identifies a retail store 930, an address 932 of the retail store 930, and a number of active alerts 934 of the retail store 930.

FIG. 9D illustrates an exemplary layout 900-D of the user interface rendered on the display 608 of the field device 320. In particular, the layout 900-D comprises a detailed view of one or more in-store execution issues of a given retail store. In one example, the layout 900-D may be generated in response to and based on selections made in one or more of the layouts 900-A, 900-B, 900-C.

The layout 900-D includes issue tiles 950a, 950b of a retail store identified by a retail store indicator 936. In one example, the retail store indicator 936 may correspond to the retail store 930 of the layout 900-C. As another example, a number of active alerts 938 may correspond to the number of active alerts 934 described in reference to the layout 900-D. Further, a number of the issue tiles 950a, 950b may correspond to the number of active alerts 938. Each issue tile 950a, 950b includes a product description 940 and a stock keeping unit (SKU) identifier 942. The issue tiles 950a, 950b also include a status selection 944, as described in reference to FIG. 9E, and an action selection 946, as described in reference to FIG. 9F.

FIG. 9E illustrates an exemplary layout 900-E of the user interface rendered on the display 608 of the field device 320. In particular, the layout 900-E comprises selection choices corresponding to a status of the product associated with the in-store execution issue alert. For example, a UI layout of the layout 900-E may accessible through actuation of the status selection 944 of the layout 900-D. Of course, in other embodiments, the layout 900-E may be navigated to by way of additional or alternative menu selections and/or invoked automatically in response to activation of the software application or when the field device 320 is detected to be in geographic proximity to the retail store where an inventory alert has been identified.

Status selections 952, 954, 956, 958 are user-activated controls indicating a status of the product associated with the in-store execution issue alert. The status selections 952, 954, 956, 958 may be mutually exclusive, such that the field agent can select only one of the status selections 952, 954, 956, 958. In other examples, the status selections 952, 954, 956, 958 are not mutually exclusive, such that the field agent can identify the status of the product by selecting simultaneously more than one of the status selections 952, 954, 956, 958. While four status selections are depicted, it is contemplated that fewer or a greater number of status selections, as well as, different categories of status selections may be provided.

The application receives user input (e.g., touch, speech, gesture, etc.) from the frontline agent that indicates whether an action has been taken regarding a given alert and/or the type of action that has been taken. The application transmits data associated with the received user input to the analytic device 104. The analytic device 104 processes the received user input and either clears (e.g., deactivates) the alert, continues monitoring the alert until further action is taken, or automatically initiates one or more actions based on the received user input.

FIG. 9F illustrates an exemplary layout 900-F of the user interface rendered on the display 608 of the field device 320. In particular, the layout 900-F comprises selection choices corresponding to an action taken to resolve one or more in-store execution issues associated with the in-store execution issue alert. For example, a UI layout of the layout 900-F may accessible through actuation of the action selection 946 of the layout 900-D. Of course, in other embodiments, the layout 900-F may be navigated to by way of additional or alternative menu selections and/or invoked automatically in response to activation of the software application or when the field device 320 is detected to be in geographic proximity to the retail store where an inventory alert has been identified.

Action selections 960, 962, 964, 966 are user-activated controls indicating an action taken to resolve execution issue associated with the in-store execution issue alert. The action selections 960, 962, 964, 966 may be mutually exclusive, such that the field agent can select only one of the action selections 960, 962, 964, 966. In other examples, the action selections 960, 962, 964, 966 are not mutually exclusive, such that the field agent can identify the actions taken to resolve the execution issue by selecting simultaneously more than one of the action selections 960, 962, 964, 966. While four action selections are depicted, it is contemplated that fewer or a greater number of action selections, as well as, different categories of action selections may be provided.

The application receives user input (e.g., touch, speech, gesture, etc.) from the frontline agent that indicates whether an action has been taken regarding a given alert and/or the type of action that has been taken. The application transmits data associated with the received user input to the analytic device 104. The analytic device 104 processes the received user input and either clears (e.g., deactivates) the alert, continues monitoring the alert until further action is taken, or automatically initiates one or more actions based on the received user input.

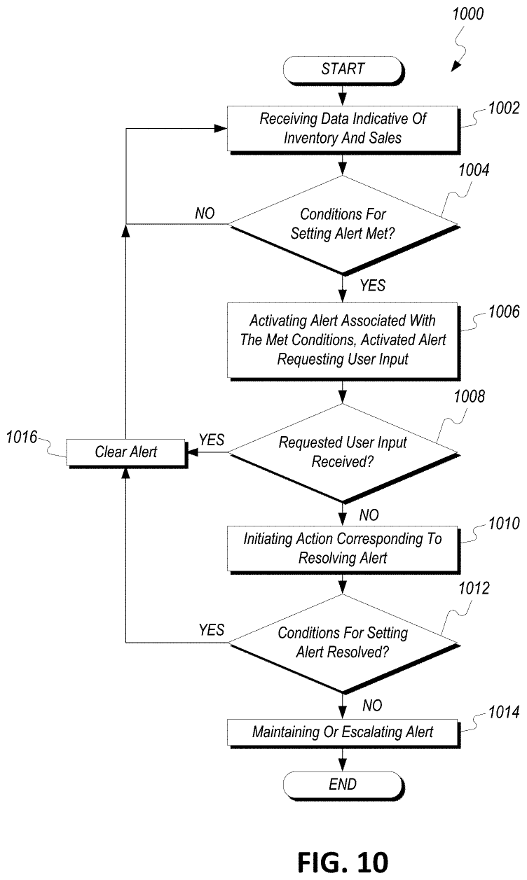

FIG. 10 illustrates an exemplary process 1000 for updating criteria for automated in-store execution issue resolution. In some embodiments, the process 1000 may be executed by the processor 404 using one or more modules of the analytic device 332 (e.g., the communication module 502, the dashboard interface module 504, the input data receipt module 506, the alert criteria module 508, the alert validity module 510, the alert criteria update module 512, etc.). The process 1000 may begin at block 1002 where the analytic device 332 receives inventory- and sales-related data, such as, but not limited to, production plans, delivery and fulfillment schedules, detailed historical and real-time sales and inventory data, historical and projected shopping trends reports, and raw material price lists.

The analytic device 332 at block 1004 determines, based on the input data from the data sources 324, whether one or more conditions for setting an in-store execution issue alert has been met. The analytic device 332 may return to block 1002 in response to determining that one or more predefined conditions for setting the alert have not been met. In some instances, one or more predefined conditions for setting the alert may comprise criteria that varies from store to store geographically or temporally from season to season.

In response to the one or more predefined conditions for setting an alert being met, the analytic device 332, at block 1006, activates the corresponding alert requesting user input. At block 1008 the analytic device 332 determines whether the requested user input has been received. In response to detecting receipt of user input, the analytic device 332 may proceed to block 1016 where it clears the alert. The analytic device 332 may then exit the process 1000.

If the requested user input is not received within a predefined period of time, such as, one or more seconds, minutes, hours, days, weeks, and so on, the analytic device 332, at block 1010, initiates at least one corresponding action to resolve the alert. At block 1012, the analytic device 332 determines whether the conditions for setting the alert have been resolved. In some instances, the analytic device 332 may clear the alert when at least one condition for activating the alert has been resolved. In other instances, the analytic device 332 clears the alert in response to each of a plurality of predetermined conditions for setting the alert having been resolved.

If the conditions for setting the alert have been resolved, the analytic device 332 may proceed to block 1016 where it clears the alert. The analytic device 332 may then exit the process 1000. Additionally or alternatively, the process 1000 proceeds to block 1014 where it maintains and/or escalates the alert in response to detecting that the one or more conditions for setting the alert have not been resolved. The process 1000 may then end. In some examples, the process 1000 may be repeated in response to input data indicating that one or more predefined conditions for setting an in-store execution issue alert has been met or in response to another indication or command.

While the concepts of the present disclosure are susceptible to various modifications and alternative forms, specific exemplary embodiments are been shown by way of example in the drawings and will be described. It should be understood, however, that there is no intent to limit the concepts of the present disclosure to the particular forms disclosed; on the contrary, the intention is to cover all modifications, equivalents, and alternatives falling within the spirit and scope of the invention as defined by the appended claims.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A system comprising:
an analytic device including a processor communicatively coupled to a plurality of data sources via a communications module of the analytic device configured to facilitate communications between the analytic device and the data sources, the data sources configured to provide data indicative of inventory and sales, the analytic device configured to:
in response to data from at least one of the data sources indicating that one or more predefined conditions has been met, automatically generate an alert requesting user input via a user interacting with a user interface communicatively connected to the analytic device and output the alert to the user interface, the alert being based on the one or more predefined conditions, the user interface being configured to output the user input to the analytic device;
in response to failing to receive user input from the user interface within a predefined period, automatically initiate at least one action configured to resolve the alert; and
following the initiating of the at least one action,
automatically deactivate the alert, in response to detecting that initiating the at least one action caused the one or more conditions to clear, and
maintain the alert in response to detecting that initiating the at least one action failed to cause the one or more conditions to clear.

2. The system of claim 1, wherein the one or more conditions relate to one of a planogram void, a promotional execution, a product of a cooler, a health and maintenance parameter of the cooler, phantom inventory, distribution void, customer service, display placement, in-stock and online grocery fill rate, on-shelf customer availability, and out-of-stock, and an increased sales opportunity.

3. The system of claim 1, wherein to generate the alert includes generating a plurality of tiles on the user interface, wherein each tile identifies a resolution to the alert, and wherein requesting user input includes requesting user selection of one of the plurality of tiles.

4. The system of claim 1, wherein to initiate at least one action to resolve the alert includes adding a product to an order.

5. The system of claim 1, wherein the one or more predefined conditions includes a number of scans of a product being less than a predefined threshold.

6. The system of claim 5, wherein the number of scans of the product is zero.

7. The system of claim 6, wherein to deactivate the alert is further in response to detecting that the number of scans of the product is greater than zero.

8. A method comprising:
in response to data from at least one of a plurality of data sources indicating that one or more predefined conditions has been met, automatically generating, by an analytic device including a processor, an alert requesting user input via a user interacting with a user interface, wherein the data is indicative of inventory and sales, wherein the analytic device is communicatively coupled to the plurality of data sources via a communications module of the analytic device configured to facilitate communications between the analytic device and the data sources, wherein the user interface is communicatively connected to the analytic device, the alert being based on the one or more predefined conditions, wherein the user interface is configured to output the user input to the analytic device;
output the alert to the user interface;
in response to failing to receive user input from the user interface within a predefined period, automatically initiating at least one action to resolve the alert via the analytic device; and
following the initiating of the at least one action,
automatically deactivating the alert via the analytic device in response to detecting that initiating the at least one action caused the one or more conditions to clear, and
maintaining the alert via the analytic device in response to detecting that initiating the at least one action failed to cause the one or more conditions to clear.

9. The method of claim 8, wherein the one or more conditions relate to one of a planogram void, a promotional execution, a product of a cooler, a health and maintenance parameter of the cooler, phantom inventory, distribution void, customer service, display placement, in-stock and online grocery fill rate, on-shelf customer availability, and out-of-stock, and an increased sales opportunity.

10. The method of claim 8, wherein generating the alert includes generating a plurality of tiles on the user interface, wherein each tile identifies a resolution to the alert, and wherein requesting user input includes requesting user selection of one of the plurality of tiles.

11. The method of claim 8, wherein initiating at least one action to resolve the alert includes adding a product to an order.

12. The method of claim 8, wherein the one or more predefined conditions includes a number of scans of a product being less than a predefined threshold.

13. The method of claim 12, wherein the number of scans of the product is zero.

14. The method of claim 13, wherein deactivating the alert is further in response to detecting that the number of scans of the product is greater than zero.

15. A system comprising:
a field personnel user application;
a plurality of data sources configured to provide data indicative of sales and inventory;
an analytics engine including a processor and communicatively coupled to the field personnel user application and the plurality of data sources via a communications module of the analytic device configured to facilitate communications between the analytic device, the data sources, and the field personnel user application, the analytics engine configured to:
in response to data from at least one of the data sources indicating that one or more predefined conditions has been met, automatically generate an alert on the field personnel user application, wherein the alert requests user input via a user interacting with a user interface communicatively connected to the analytic device and output the alert to the user interface, the alert being based on the one or more predefined conditions, the user interface being configured to output the user input to the analytics engine;
in response to failing to receive user input from the user interface within a predefined period, automatically initiate at least one action to resolve the alert; and
following the initiating of the at least one action,
automatically deactivate the alert in response to detecting that initiating the at least one action caused the one or more conditions to clear, and
maintain the alert in response to detecting that initiating the at least one action failed to cause the one or more conditions to clear.

16. The system of claim 15, wherein to generate the alert includes generating a plurality of tiles on the user interface, wherein each tile identifies a resolution to the alert, and wherein requesting user input includes requesting user selection of one of the plurality of tiles.

17. The system of claim 15, wherein to initiate at least one action to resolve the alert includes adding a product to an order.

18. The system of claim 15, wherein the one or more predefined conditions includes a number of scans of a product being less than a predefined threshold.

19. The system of claim 18, wherein the number of scans of the product is zero.

20. The system of claim 19, wherein to deactivate the alert is further in response to detecting that the number of scans of the product is greater than zero.
